(19) United States
(12) Patent Application Publication
(10) Pub. No.: US 2024/0078725 A1
(43) Pub. Date: Mar. 7, 2024

(54) INFRASTRUCTURE DIAGNOSTIC DEVICE, INFRASTRUCTURE DIAGNOSTIC METHOD, AND RECORDING MEDIUM

(71) Applicant: NEC Corporation, Minato-ku, Tokyo (JP)

(72) Inventors: Yosuke Kimura, Tokyo (JP); Nana Jumonji, Tokyo (JP); Chisato Sugawara, Tokyo (JP); Toru Takami, Tokyo (JP); Hiroshi Nakasato, Tokyo (JP)

(73) Assignee: NEC Corporation, Minato-ku, Tokyo (JP)

(21) Appl. No.: 18/269,208

(22) PCT Filed: Mar. 25, 2021
(86) PCT No.: PCT/JP2021/012602

§ 371 Date: Jun. 22, 2023

(51) Int. Cl. G06T 11/20

(52) U.S. Cl. CPC G06T 11/206

(57) ABSTRACT

An infrastructure diagnostic device comprises a time-series display control unit, a reception unit, and a location display control unit. The time-series display control unit displays the infrastructure states of a plurality of locations in a predetermined area in time series on a display. The reception unit receives selection of data from among the time series for the infrastructure states of the plurality of locations. The location display control unit displays, on a map, a location corresponding to the selected data on the display.

### TECHNICAL FIELD

The present disclosure relates to an infrastructure diagnostic device, an infrastructure diagnostic method, and a recording medium.

### BACKGROUND ART

There is known a system for evaluating the state of a road infrastructure (road surfaces, guard rails, signs, street lamps, etc.) by analyzing images and accelerations collected by traveling vehicles. For example, PTL 1 discloses a road state management program that determines a road state and displays a list of changes in the road state in time series for each road management unit. The program of PTL 1 assigns display elements such as colors, patterns, graphics, symbols, and characters in such a way as to be relevant to various indexes of road state to be determined, and displays these indexes for each management unit on roads on a road map.

### CITATION LIST

### Patent Literature

PTL 1: JP 2018-084126 A

### SUMMARY OF INVENTION

### Technical Problem

The administrators or the like of roads confirm the speed of deterioration or the like from temporal changes in the road state as described above, and determines the parts in roads to be handled on a priority basis such as investigation or repair (hereinafter, also described as prioritized parts). In order to determine the prioritized parts using the technology as described in PTL 1, the administrators or the like need to repeatedly select the management unit and refer to the time-series changes in each index of the road state in the road management unit. In general, if there are a large number of roads to be managed or in a wide area, the number of management units becomes enormous. For this reason, it is inefficient to determine the prioritized parts by such repetitive work.

An object of the present disclosure is to provide an infrastructure diagnostic device, an infrastructure diagnostic method, and a recording medium capable of solving the above-described problems and efficiently determining prioritized parts in a road infrastructure.

### Solution to Problem

An infrastructure diagnostic device according to an aspect of the present disclosure includes: a first display control means that displays a time series of an infrastructure state at a plurality of locations in a predetermined area on a display means; a reception means that receives selection of any one of the time series of the infrastructure state at the plurality of locations; and a second display control means that displays a location associated to the selected time series on a map on the display means.

An infrastructure diagnostic method according to an aspect of the present disclosure includes: displaying a time series of an infrastructure state at a plurality of locations in a predetermined area on a display means; receiving selection of any one of the time series of the infrastructure state at the plurality of locations; and displaying a location associated to the selected time series on a map on the display means.

A recording medium according to one aspect of the present disclosure records a program for causing a computer to execute a process of displaying a time series of an infrastructure state at a plurality of locations in a predetermined area on a display means; receiving selection of any one of the time series of the infrastructure state at the plurality of locations; and displaying a location associated to the selected time series on a map on the display means.

### Advantageous Effects of Invention

An advantageous effect of the present disclosure is that prioritized parts in a road infrastructure can be efficiently determined.

### BRIEF DESCRIPTION OF DRAWINGS

FIG. 1 is a block diagram illustrating a configuration of an infrastructure diagnostic system 10 in a first example embodiment.

FIG. 2 is a block diagram illustrating an example of configuration of an infrastructure diagnostic device 20 in the first example embodiment.

FIG. 3 is a diagram illustrating an example of sensor information in the first example embodiment.

FIG. 4 is a diagram illustrating an example of detection results of state of a road infrastructure in the first example embodiment.

FIG. 5 is a diagram illustrating an example of a state time series in the first example embodiment.

FIG. 6 is a flowchart of a state detection process in the first example embodiment.

FIG. 7 is a flowchart of a detection result display process in the first example embodiment.

FIG. 8 is a diagram illustrating an example of a plurality of locations (locations A to D) in a predetermined area in the first example embodiment.

FIG. 9 is a diagram illustrating an example of a time-series selection screen (table form) in the first example embodiment.

FIG. 10 is a diagram illustrating an example of a time-series selection screen (graph form) according to the first example embodiment.

FIG. 11 is a diagram illustrating a display example of a map screen in the first example embodiment.

FIG. 12 is a diagram illustrating a display example of a state time series in a table form in modification 1 of the first example embodiment.

FIG. 13 is a diagram illustrating a display example of a state time series in a graph form in modification 1 of the first example embodiment.

FIG. 14 is a diagram illustrating a calculation example of change rates of a value of an index in modification 2 of the first example embodiment.

FIG. 15 is a diagram illustrating a display example of a state time series in a graph form in modification 3 of the first example embodiment.

FIG. 16 is a block diagram illustrating a configuration of an infrastructure diagnostic device 1 in a second example embodiment.

FIG. 17 is a block diagram illustrating an example of a hardware configuration of a computer 500.

### EXAMPLE EMBODIMENT

### First Example Embodiment

A first example embodiment will be described.

### System Configuration

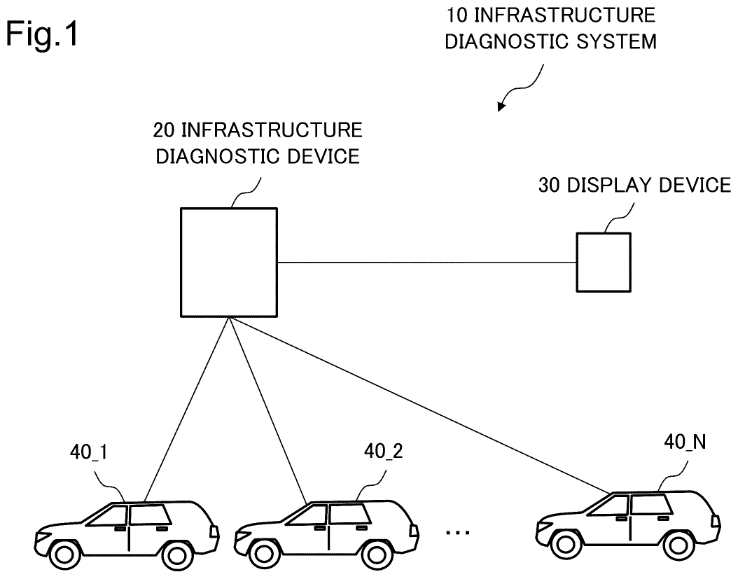

First, a configuration of an infrastructure diagnostic system according to the first example embodiment will be described. FIG. 1 is a block diagram illustrating a configuration of an infrastructure diagnostic system 10 in the first example embodiment. Referring to FIG. 1, the infrastructure diagnostic system 10 includes an infrastructure diagnostic device 20, a display device 30, and a plurality of vehicles 40_1, 40_2, . . . 40_N (N is a natural number) that are moving objects (hereinafter, collectively referred to as vehicles 40). The moving objects may be motorcycles, bicycles, drones, robots, or vehicles with a self-driving function, or persons (pedestrians).

The vehicle 40 acquires predetermined sensor information acquired by mounted sensors. The sensor information includes image, acceleration, acquisition date and time, position, and others. The image is an image of surface a road that is captured (acquired) by an imaging device such as a camera of a drive recorder mounted in the vehicle 40 while traveling on the road, for example. The acceleration is acquired by an acceleration sensor mounted in the vehicle 40 while traveling on a road, and represents unevenness of the road surface as vertical vibration, for example. The position is acquired by a position detection sensor such as a global positioning system (GPS) while an image is captured by the imaging device or while acceleration is acquired by the acceleration sensor. The vehicle 40 transmits the sensor information including the image, the acceleration, the acquisition date and time of the information, and the position to the infrastructure diagnostic device 20. For example, the position may be represented by using latitude and longitude. In relation to the present example embodiment, a case where both the image and the acceleration are included in the sensor information will be described. However, the present invention is not limited thereto, and at least one of the image and the acceleration may be included.

The infrastructure diagnostic device 20 detects the state of a road infrastructure at a plurality of locations in a predetermined area based on the sensor information transmitted from the vehicle 40. The infrastructure diagnostic device 20 displays the time-series changes in the state of the road infrastructure at each location on the display device 30, thereby presenting the information to the user of the infrastructure diagnostic device 20. The road infrastructure here is a road surface, for example. The road infrastructure may be markings such as stop lines or a center lines on a road surface, equipment such as guardrails or signs installed on a road, or structures such as bridges or tunnels constituting a road. The user is a staff member (manager or worker) of a business company, for example.

The infrastructure diagnostic device 20 and the display device 30 are arranged in an equipment management facility of a company, for example. The infrastructure diagnostic device 20 and the display device 30 may be integrated or separated. The infrastructure diagnostic device may be arranged in other than the equipment management facility of the business company. In this case, the infrastructure diagnostic device may be implemented by a cloud computing system.

A publicly known technique using image analysis or acceleration analysis is used in a method of detecting the state of a road infrastructure based on the sensor information. Examples of detection using image analysis include a method of analyzing the state of a road infrastructure using artificial intelligence (AI). Examples of detection using acceleration analysis include a method of detecting the degree of unevenness of a road surface using acceleration in a direction perpendicular to the road surface.

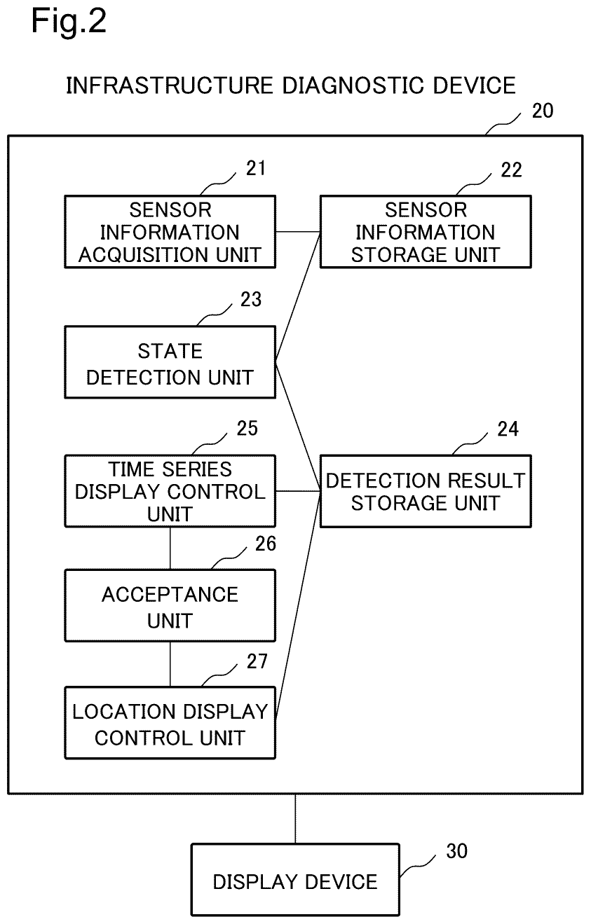

FIG. 2 is a block diagram illustrating an example of configuration of the infrastructure diagnostic device 20 in the first example embodiment. As illustrated in FIG. 2, the infrastructure diagnostic device 20 includes a sensor information acquisition unit 21, a sensor information storage unit 22, a state detection unit 23, a detection result storage unit 24, a time-series display control unit 25, a reception unit 26, and a location display control unit 27. The time-series display control unit 25, the reception unit 26, and the location display control unit 27 are example embodiments of a first display control means, a reception means, and a second display control means of the present disclosure, respectively.

The sensor information acquisition unit 21 acquires sensor information from the vehicle 40. The sensor information acquisition unit 21 outputs the acquired sensor information to the sensor information storage unit 22.

The sensor information storage unit 22 stores the sensor information output by the sensor information acquisition unit 21.

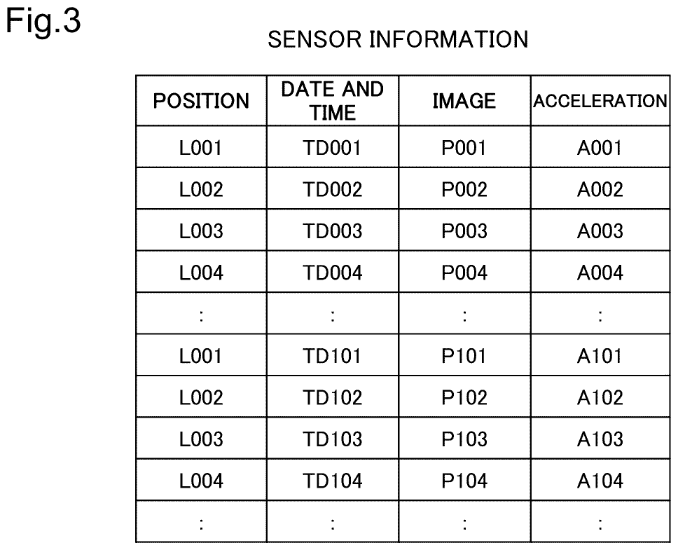

FIG. 3 is a diagram illustrating an example of sensor information in the first example embodiment. The example of the sensor information illustrated in FIG. 3 includes date and time, position, image, and acceleration. The date and time indicate the date and time when the vehicle 40 acquired an image and an acceleration. The position indicates the position where the image and the acceleration were acquired. FIG. 3 illustrates that images and accelerations were acquired at the same position on different dates and times. The position (location) may be identified by predetermined range (for example, a divided regional mesh or the like) on a map. In this case, positions included in the same predetermined range on the map may be regarded as the same position. For example, a mesh with a side length of about 250 m or a mesh with a side length of about 125 m obtained by dividing the former mesh into two equal parts vertically and horizontally may be used as the divided regional mesh. Furthermore, as a regional mesh obtained by further subdividing the divided regional mesh, a mesh with a side length of about 62.5 m or a mesh shorter than that may be used, for example.

The state detection unit 23 detects the state of the road infrastructure based on at least one of the image and the acceleration included in the sensor information, and calculates a value of an index indicating the state. In the first example embodiment, the state detection unit 23 detects a deterioration state as the state of the road infrastructure, and calculates a value of an index indicating the degree of deterioration.

If the road infrastructure is a road surface, a crack rate, a rutting amount, flatness, maintenance control index (MCI), international roughness index (IRI), or the like is used as an index, for example. In this case, another index indicating the degree of deterioration of the road surface, such as the size and depth of a pot hole, may be used as the index.

If the road infrastructure indicates markings on the road surface, an index indicating the degree of blurring of a marking is used as the index, for example. If the road infrastructure is a facility installed on the road or a structure constituting the road, an index indicating the degree of rust, damage, or deformation of the facility or the structure is used as the index, for example.

The state detection unit 23 may detect, as the state of the road infrastructure, other than the deterioration state, such as the progress of maintenance and construction, the depth and size of a puddle, the amount of snow, the amount of dust and foreign matter, and the size and degree of bush of planting and trees.

The state detection unit 23 outputs detection results of the state of the road infrastructure to the detection result storage unit 24.

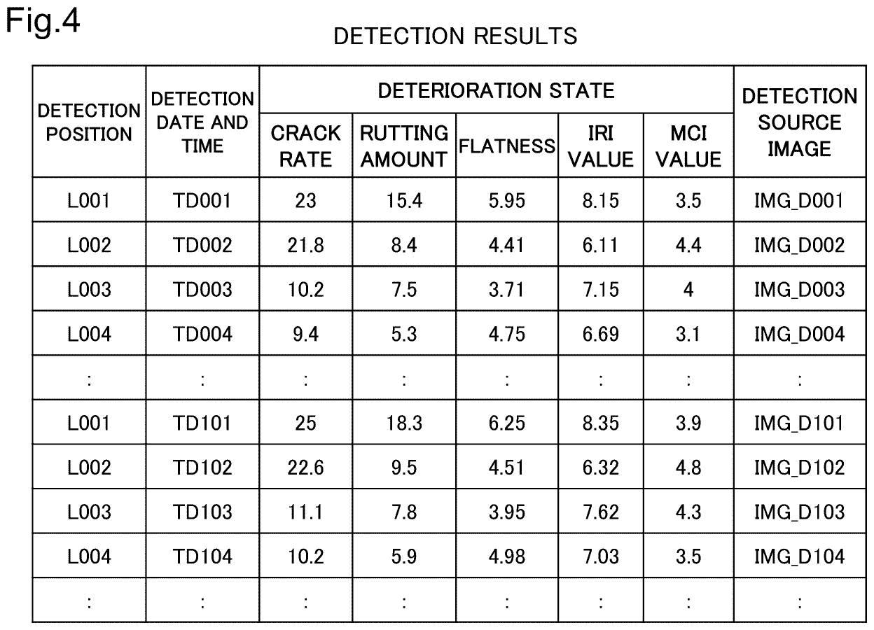

FIG. 4 is a diagram illustrating an example of detection results of state of the road infrastructure in the first example embodiment. The detection results in FIG. 4 are results of detection based on the sensor information in FIG. 3. In the example of FIG. 4, the detection results include detection date and time, detection position, crack rate, rutting amount, flatness, IRI value, MCI value, and detection source image. The detection date and time, the detection position, and the detection source image are the date and time, the position, and the image included in the sensor information in which the state of the road infrastructure is detected.

The detection result storage unit 24 stores a time series of the detection results of the state of the road infrastructure output from the state detection unit 23 as state time-series at each detection position.

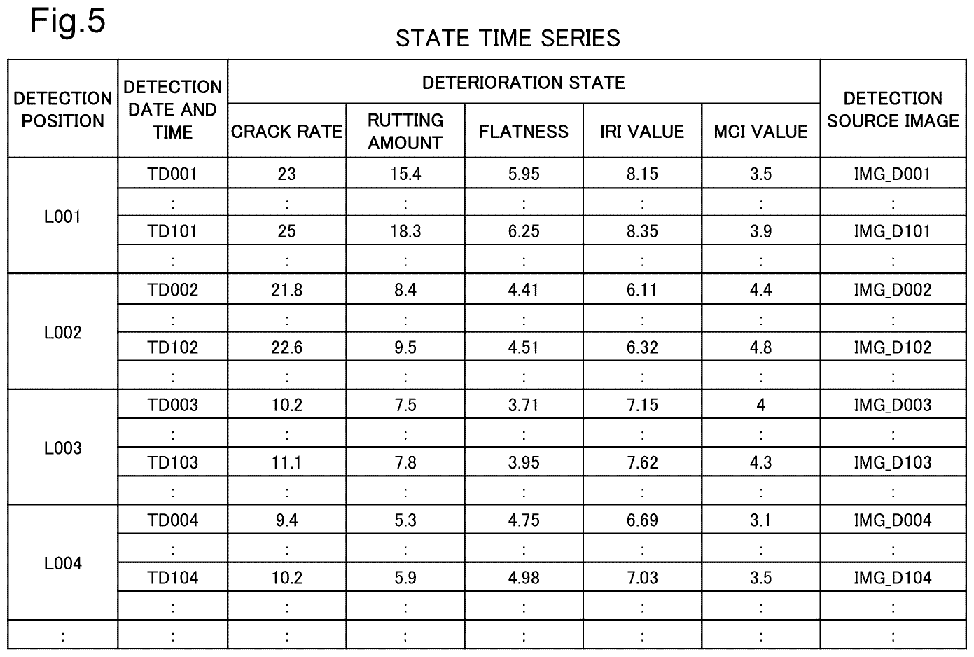

FIG. 5 is a diagram illustrating an example of a state time series in the first example embodiment. The state time series in FIG. 5 is information obtained by rearranging the detection results in FIG. 4 in time series at each detection position.

The time-series display control unit 25 displays the state time series of the infrastructure state at each of the plurality of locations (detection positions) in a predetermined area on the display device 30.

The reception unit 26 receives selection of any one of the state time series of the infrastructure state at each location displayed on the display device 30.

The location display control unit 27 displays a location associated to the selected state time series on the map on the display device 30.

Next, an operation of the first example embodiment will be described.

(State Detection Process)

The state detection process will be described. The state detection process is a process of detecting the state of the road infrastructure at each detection position based on the sensor information transmitted from each vehicle 40. Hereinafter, the state detection process will be described using the sensor information in FIG. 3, the detection results in FIG. 4, and the state time series in FIG. 5.

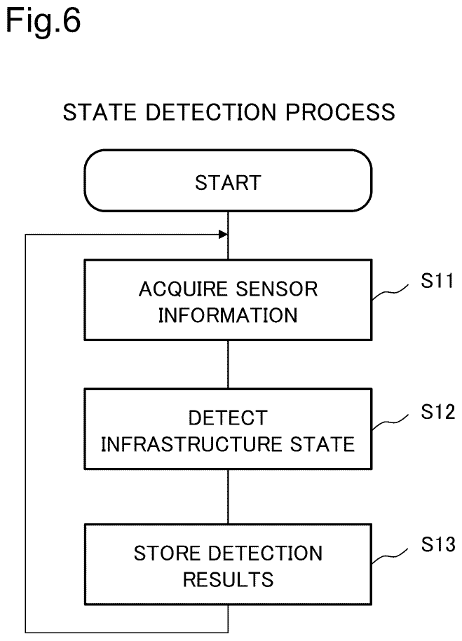

FIG. 6 is a flowchart of the state detection process in the first example embodiment. The sensor information acquisition unit 21 of the infrastructure diagnostic device 20 acquires the sensor information (date and time, position, image, and acceleration) transmitted from the vehicle 40, for example (step S11). For example, the sensor information acquisition unit 21 acquires sensor information as shown in FIG. 3. The sensor information acquisition unit 21 stores the acquired sensor information in the sensor information storage unit 22.

The state detection unit 23 acquires the sensor information from the sensor information storage unit 22, and detects the state of the road infrastructure at the position in the sensor information, based on the acquired sensor information (step S12). For example, the state detection unit 23 detects the state of the road infrastructure based on the sensor information of the position “L001” and the date and time “TD001” in FIG. 3. In this case, the state detection unit 23 obtains values of the indices of the state of the road infrastructure indicated by the detection position “L001” and the detection date and time “TD001” in FIG. 4 as the detection results.

The state detection unit 23 stores the detection results in time series at each detection position in the detection result storage unit 24 (step S13). For example, the state detection unit 23 stores the detection results illustrated in FIG. 4 in the detection result storage unit 24, as the state time series illustrated in FIG. 5.

Thereafter, the process from step S11 is repeated.

(Detection Result Display Process)

The detection result display process will be described. The detection result display process is a process of displaying the detection results of the state of the road infrastructure in accordance with the selection of the state time series by the user. Hereinafter, the detection result display process will be described using the state time series in FIG. 5.

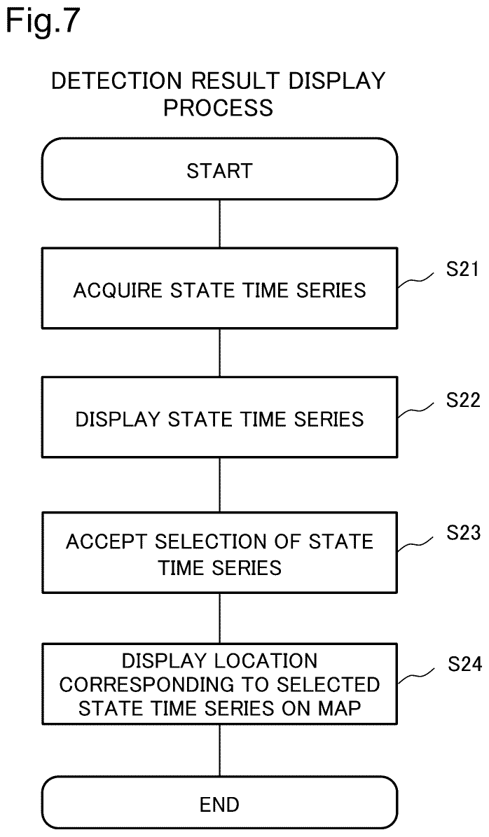

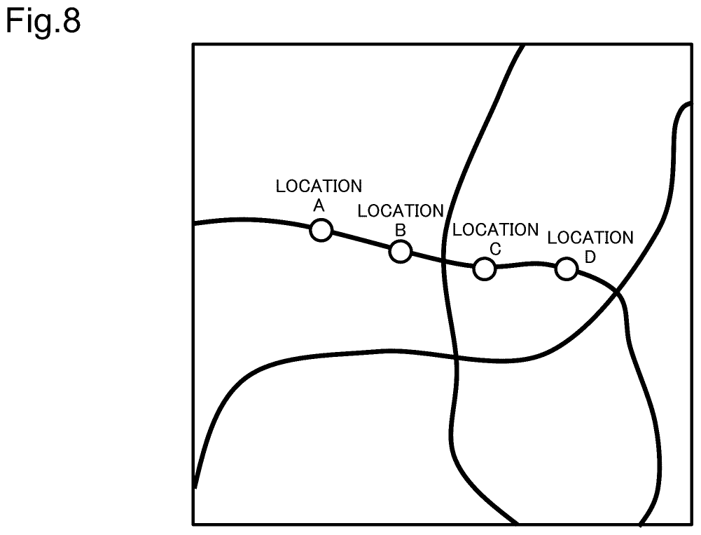

FIG. 7 is a flowchart of a detection result display process in the first example embodiment. The time-series display control unit 25 acquires the state time series at each location in the predetermined area from the detection result storage unit 24 (step S21). FIG. 8 is a diagram illustrating an example of a plurality of locations (locations A to D) in the predetermined area in the first example embodiment. The locations A to D illustrated in FIG. 8 associate to the detection positions “L001” to “L004” in FIG. 5, respectively. For example, the time-series display control unit 25 acquires the state time series of the detection positions “L001” to “L004” in FIG. 5 corresponding to the locations A to D in FIG. 8 from the detection result storage unit 24. The predetermined area here may be a section (mesh) in which regions are divided by a predetermined length, or may be an area selected by the user using an operation device such as a mouse on a map, for example.

The time-series display control unit 25 displays the acquired state time series in a predetermined display mode (step S22) on the display device 30. The time-series display control unit 25 displays the time series of a specific index in the state time series at each location. The specific index may be specified in advance or selected by the user. The time-series display control unit 25 displays a time series selection screen on which the state time series at a plurality of locations (time series of a specific index) is represented in a table form or a graph form.

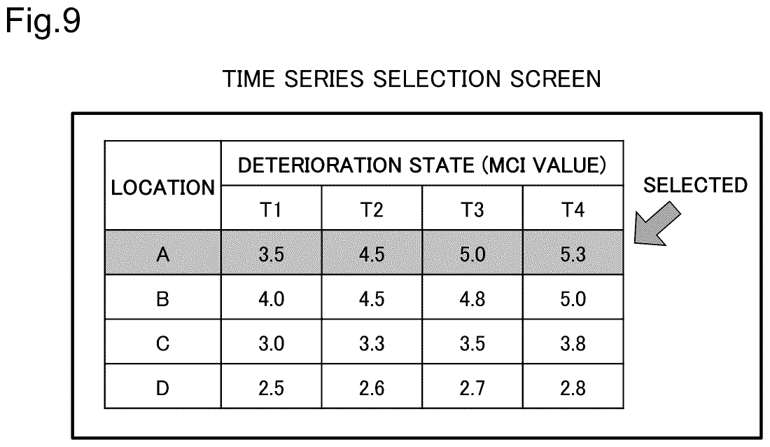

FIG. 9 is a diagram illustrating an example of a time-series selection screen (table form) in the first example embodiment. In the example of FIG. 9, a time series of deterioration states (MCI values) at times T1 to T4 at the locations A to D in FIG. 8 are represented in a table form. The deterioration states at the times T1 to T4 in FIG. 9 may be deterioration state in time slots from the time to the next time (for example, for T1, T1≤time<T2). In this case, the deterioration state in each time slot may include a statistical value such as an average value or a maximum value of the deterioration state in the time slot. The length of the time slot may be a predetermined period such as one day, one week, one month, or one year, for example.

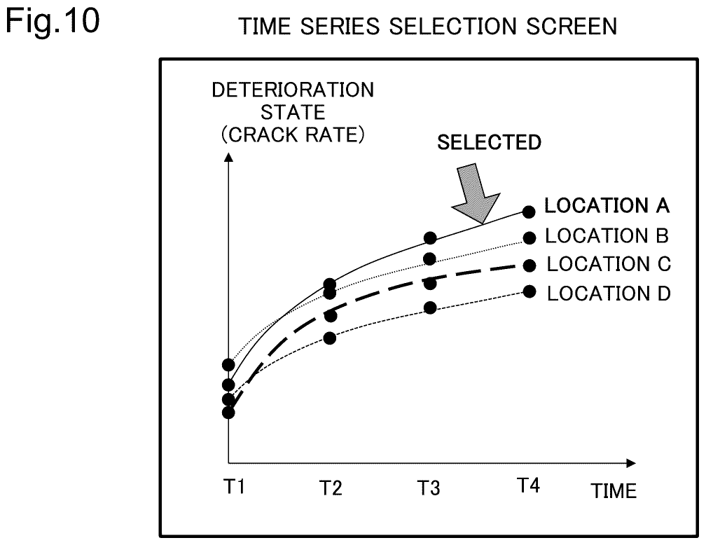

FIG. 10 is a diagram illustrating an example of a time-series selection screen (graph form) according to the first example embodiment. In the example of FIG. 10, a time series of deterioration states (crack rates) at the times T1 to T4 at the locations A to D in FIG. 8 are represented in a graph form.

The reception unit 26 receives the user's selection of any one of the state time series displayed in the predetermined display mode (step S23). In a case where the state time series are displayed in a table form as illustrated in FIG. 9, the reception unit 26 receives the selection of the state time series in a row clicked by the user, for example. In a case where the state time series are displayed in a graph form as illustrated in FIG. 10, the reception unit 26 receives the selection of the state time series in a curve clicked by the user, for example.

For example, the reception unit 26 receives the user's selection of the state time series at the location A in the display of the state time series in FIG. 9 or 10.

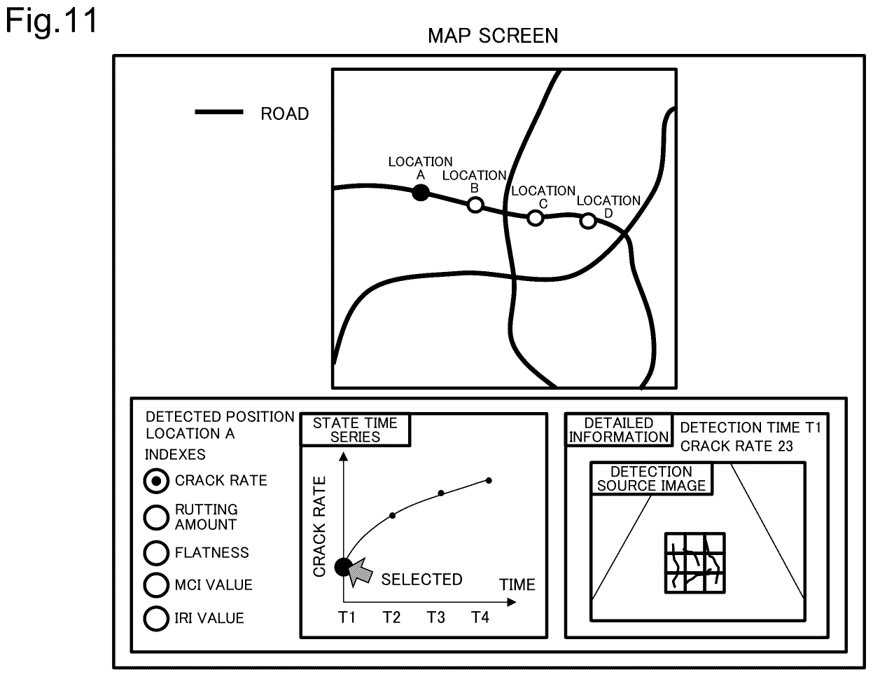

The location display control unit 27 displays a location (position) associated to the state time series selected by the user on the map on the display device 30 (step S24). FIG. 11 is a diagram illustrating a display example of a map screen in the first example embodiment. FIG. 11 is an example of a map screen in a case where the time series at the location A is selected on the time series selection screen (graph format) in FIG. 10. In the example of FIG. 11, the location A associated to the state time series selected by the user is shown on the map. The state time series (a time series of a deterioration state (crack rate)) at the location A and detailed information thereof are displayed. As the detailed information, the value of each index of the time (detection date and time) selected on the state time series and the detection source image obtained from the detection results are displayed. By clicking a radio button for selecting an index on the screen illustrated in FIG. 11, the contents of the state time series and the detailed information may be changed to the contents of the index selected by the radio button.

Thus, the operation of the first example embodiment is completed.

### Modification 1 of First Example Embodiment

In the first example embodiment described above, the state time series at locations in a predetermined area are displayed and selected by the user. If the number of locations in the predetermined area is large, a large number of state time series are displayed and thus it is difficult for the user to select the state time series. Therefore, among the state time series at the locations, a state time series in which the value of the index representing the state of the road infrastructure satisfies a predetermined condition may be displayed.

In this case, the time-series display control unit 25 displays the state time series in which the value of the index representing the state of the road infrastructure satisfies the predetermined condition among the state time series at individual locations in the predetermined area acquired from the detection result storage unit 24, in a predetermined display mode on the display device 30. The predetermined condition is that “the value of the index representing the deterioration state is equal to or more than a predetermined threshold at a predetermined time point such as any time point or the latest time point”, for example.

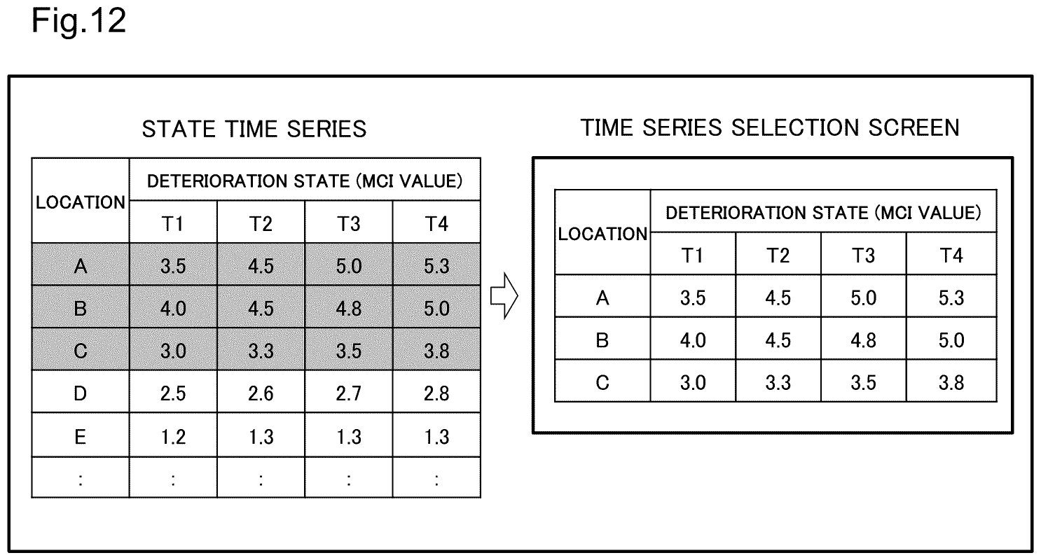

FIG. 12 is a diagram illustrating a display example of state time series in a tabular form in modification 1 of the first example embodiment. For example, it is assumed that the state time series in FIG. 12 are obtained from the detection result storage unit 24 and the threshold of the MCI value is “3.5”. In this case, the time-series display control unit 25 displays the state time series at the locations A to C including the MCI values of greater than or equal to the threshold value “3.5” as seen on the time series selection screen in FIG. 12.

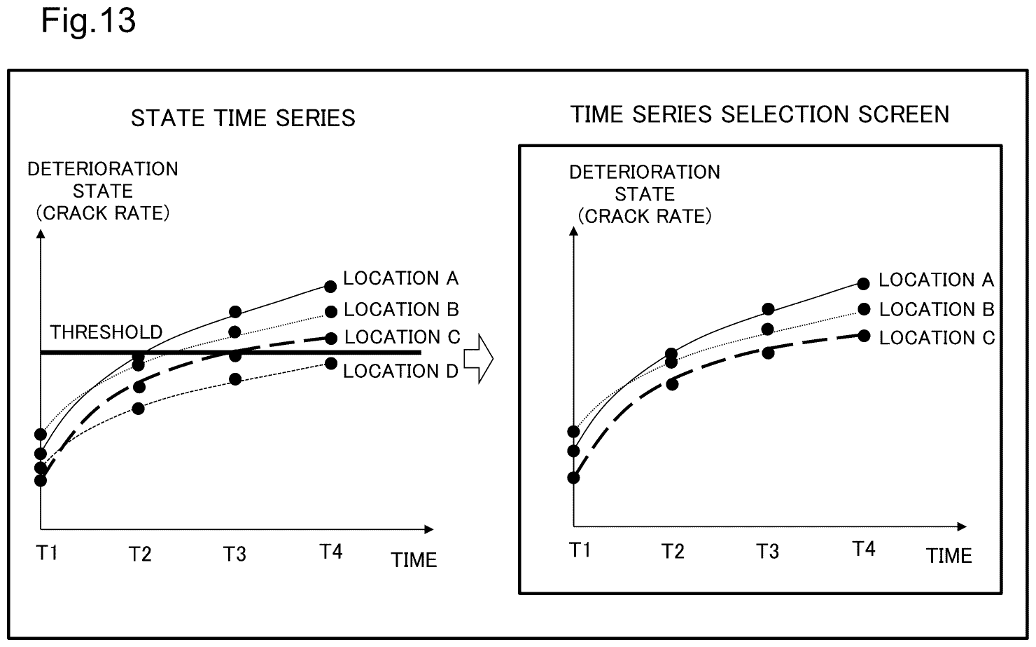

FIG. 13 is a diagram illustrating a display example of state time series in a graph form in modification 1 of the first example embodiment. For example, it is assumed that the state time series in FIG. 13 are obtained from the detection result storage unit 24, and the threshold of the crack rate is shown by a thick line. In this case, the time-series display control unit 25 displays the state time series at the locations A to C including the crack rates equal to or more than the threshold (thick line) as seen on the time series selection screen in FIG. 13.

As a result, in modification 1 of the first example embodiment, it is possible to efficiently determine the prioritized parts even when the number of locations is large.

### Modification 2 of First Example Embodiment

In modification 1 of the first example embodiment, the state time series in which the value of the index representing the state of the road infrastructure satisfies the predetermined condition are displayed. Alternatively, a state time series in which a change in the value of the index representing the state of the road infrastructure satisfies a predetermined condition may be displayed. In this case, the predetermined condition is that “the change rate of a value of an index representing the deterioration state during a predetermined period is equal to or more than a predetermined threshold”, for example.

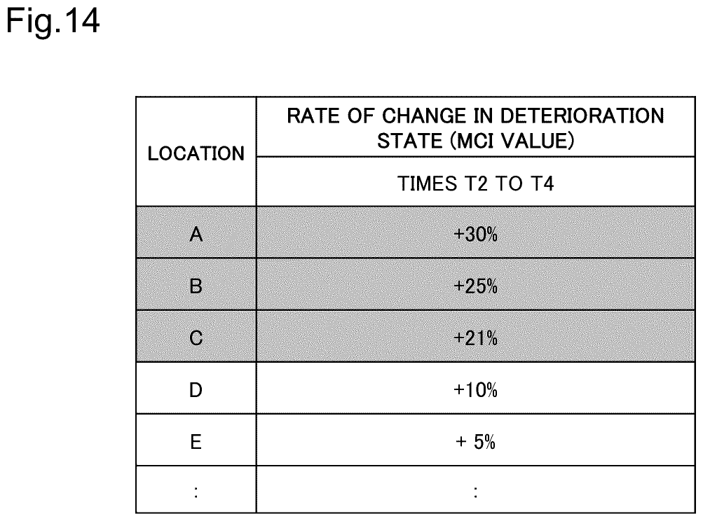

FIG. 14 is a diagram illustrating a calculation example of change rates of a value of an index in modification 2 of the first example embodiment. For example, it is assumed that state time series similar to those in FIG. 12 are obtained from the detection result storage unit 24. It is also assumed that the threshold of the change rate of the MCI value in the latest three time slots is “20%”. In this case, the time-series display control unit 25 calculates the change rate of the MCI value in each state time series as illustrated in FIG. 14. The time-series display control unit then displays the state time series at the locations A to C indicating the change rates equal to or more than the threshold “20%, similarly to the time series selection screen in FIG. 12.

As a result, even in modification 2 of the first example embodiment, it is possible to efficiently determine the prioritized parts even in a case where the number of locations is large.

### Modification 3 of First Example Embodiment

In the above description of the first example embodiment, the reception unit 26 receives the selection of the state time series. In addition to the state time series, the reception unit 26 may further receive selection of a time point in the state time series. In this case, the location display control unit 27 may display detailed information of the deterioration state at the selected time point in the selected state time series.

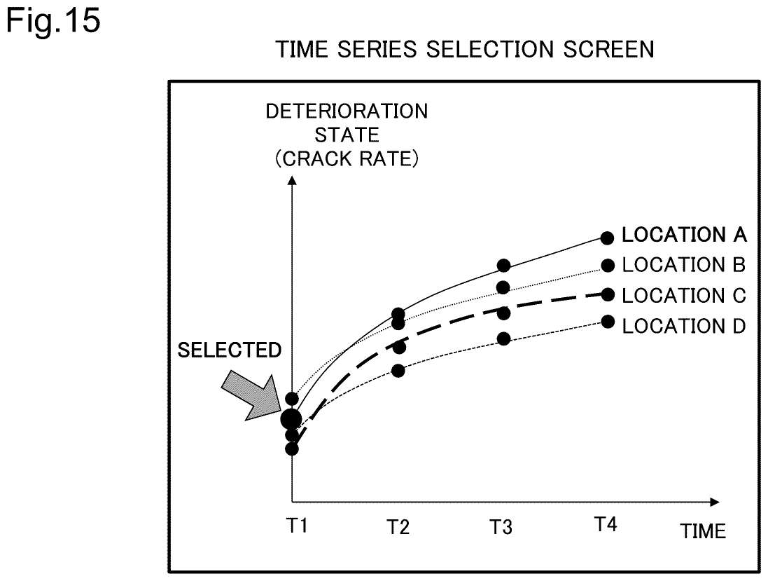

FIG. 15 is a diagram illustrating a display example of state time series in a graph form in modification 3 of the first example embodiment. For example, the reception unit 26 receives selection of the state time series and the time point by the user clicking the time point on the curve in the graph of state time series in FIG. 15. For example, referring to FIG. 15, the reception unit 26 receives selection of the time T1 as the state time series at the location A by the user.

The location display control unit 27 displays a location (position) associated to the state time series selected by the user on the map on the display device 30. At that time, the location display control unit 27 displays detailed information of the selected time as detailed information of the deterioration state at the location. For example, the location display control unit 27 displays the detection source image associated to the detection date and time (time T1) at the location (location A) as “image of selected location”, similarly to the case in FIG. 11.

As a result, in modification 3 of the first example embodiment, it is possible to make a direct transition from the detection result time series to the screen for acquiring the detailed information at the time point requiring confirmation, and it is possible to more efficiently determine the prioritized parts.

### Modification 4 of First Example Embodiment

In the first example embodiment described above, the state detection unit 23 stores the detection results at each detection position as the state time series in the detection result storage unit 24. Alternatively, the state detection unit 23 may store the detection results in the detection result storage unit 24 without rearranging the detection results in time series. In this case, the time-series display control unit may acquire the detection results at each detection position from the detection result storage unit 24 and rearrange the detection results to generate the state time series.

### Advantageous Effects of First Example Embodiment

According to the first example embodiment, it is possible to efficiently determine the prioritized parts in the road infrastructure. This is because the time-series display control unit 25 of the infrastructure diagnostic device 20 displays the time series of the infrastructure state at the plurality of locations in the predetermined area on the display device 30, the reception unit 26 receives selection of any one of the time series of the infrastructure state at the plurality of locations, and the location display control unit 27 displays the location associated to the selected time series on the map on the display device 30.

### Second Example Embodiment

A second example embodiment will be described.

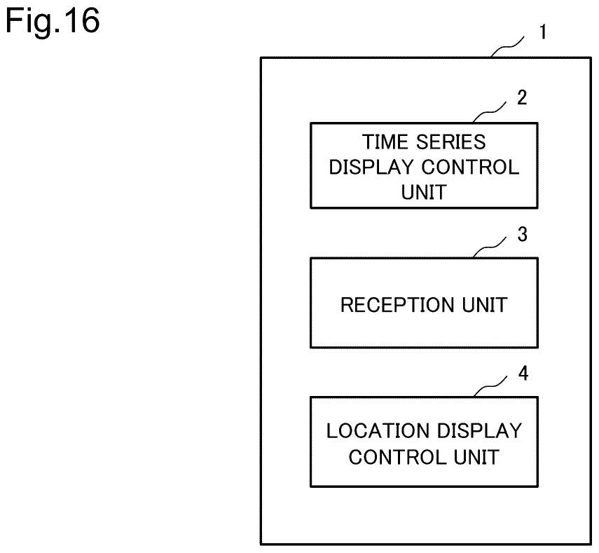

FIG. 16 is a block diagram illustrating a configuration of an infrastructure diagnostic device 1 in the second example embodiment. The infrastructure diagnostic device 1 includes a time-series display control unit 2, a reception unit 3, and a location display control unit 4. The time-series display control unit 2, the reception unit 3, and the location display control unit 4 are example embodiments of a first display control means, a reception means, and a second display control means of the present disclosure, respectively. In addition, the time-series display control unit 2, the reception unit 3, and the location display control unit 4 correspond to the time-series display control unit 25, the reception unit 26, and the location display control unit 27 of the first example embodiment, respectively.

The time-series display control unit 2 displays the infrastructure states of a plurality of locations in a predetermined area in time series on a display means. The reception unit 3 receives selection from among the time series for the infrastructure states of the plurality of locations. The location display control unit 4 displays, on a map, a location associated to the selected time series on the display means.

### Advantageous Effects of Second Example Embodiment

According to the second example embodiment, it is possible to efficiently determine the prioritized parts in the road infrastructure. This is because the time-series display control unit 2 of the infrastructure diagnostic device 1 displays the time series of the infrastructure state at the plurality of locations in the predetermined area on the display means, the reception unit 3 receives selection of any one of the time series of the infrastructure state at the plurality of locations, and the location display control unit 4 displays the location associated to the selected time series on the map on the display means.

(Hardware Configuration)

In each of the example embodiments described above, components of the infrastructure diagnostic devices 1 and 20 represent functional-unit blocks. Some or all of the components of these devices may be implemented by any combination of the computer 500 and a program. The program may be recorded in a non-volatile recording medium. The non-volatile recording medium is a compact disc read only memory (CD-ROM), a digital versatile disc (DVD), a solid state drive (SSD), or the like, for example.

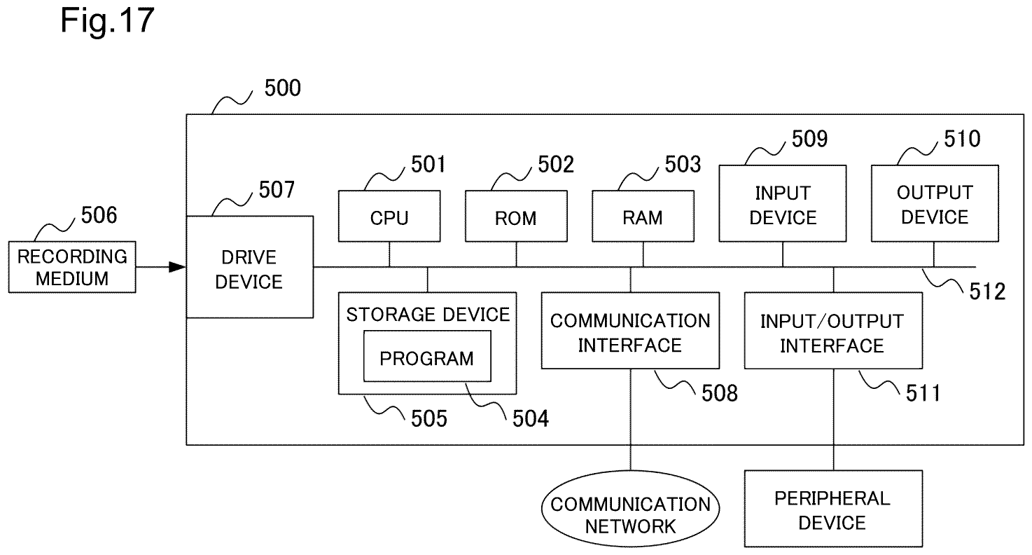

FIG. 17 is a block diagram illustrating an example of a hardware configuration of the computer 500. Referring to FIG. 17, the computer 500 includes a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512, for example.

The program 504 includes instructions for implementing the functions of the devices. The program 504 is stored in advance in the ROM 502, the RAM 503, and the storage device 505. The CPU 501 implements the functions of the devices by executing instructions included in the program 504. For example, the CPU 501 of the infrastructure diagnostic device 20 executes commands included in the program 504 to implement the functions of the sensor information acquisition unit 21, state detection unit 23, time-series display control units 2 and 25, reception units 3 and 26, and location display control units 4 and 27. The RAM 503 may store data to be processed in the functions of the devices. For example, the RAM 503 of the infrastructure diagnostic device 20 may store data (sensor information) of the sensor information storage unit 22, data (detection results and state time series) of the detection result storage unit 24, and others.

The drive device 507 reads and writes the recording medium 506. The communication interface 508 provides an interface with a communication network. The input device 509 is a mouse, a keyboard, or the like, and receives an input of information from an operator or the like, for example. The output device 510 is a display, for example, and outputs (displays) information to an operator or the like. The input/output interface 511 provides an interface with peripheral devices. The bus 512 connects the respective components of the hardware. The program 504 may be supplied to the CPU 501 via a communication network, or may be stored in the recording medium 506 in advance, read by the drive device 507, and supplied to the CPU 501.

The hardware configuration illustrated in FIG. 17 is an example, and other components may be added or some components may not be included.

There are various modifications of methods for implementing each device. For example, each device may be implemented by an any combination of a computer and a program different for each component. In addition, a plurality of components included in each device may be implemented by any combination of one computer and a program.

Some or all of the components of each device may be implemented by general-purpose or dedicated circuitry including a processor or the like, or a combination thereof. The circuitry may be configured by a single chip or may be configured by a plurality of chips connected via a bus. Some or all of the components of each device may be implemented by a combination of the above-described circuit or the like and a program.

If some or all of the components of each device are implemented by a plurality of computers, circuitry, and the like, the plurality of computers, circuitry, and the like may be arranged in a centralized manner or in a distributed manner.

Although the present disclosure has been described with reference to the example embodiments, the present disclosure is not limited to the example embodiments. Various modifications that can be understood by those skilled in the art can be made to the configurations and details of the present disclosure within the scope of the present disclosure. In addition, the configurations of the example embodiments can be combined with each other without departing from the scope of the present disclosure.

### REFERENCE SIGNS LIST

10 Infrastructure diagnostic system
1, 20 Infrastructure diagnostic device
2, 25 Time-series display control unit
3, 26 reception unit
4, 27 Location display control unit
21 Sensor information acquisition unit
22 Sensor information storage unit
23 State detection unit
24 Detection result storage unit
500 Computer
501 CPU
502 ROM
503 RAM
504 Program
505 Storage device
506 Recording medium
507 Drive device
508 Communication interface
509 Input device
510 Output device
511 Input/output interface
512 Bus

What is claimed is:

1. An infrastructure diagnostic device comprising:
a memory storing instructions; and
one or more processors configured to execute the instructions to:
display a plurality of time series on a display, each time series representing infrastructure states at any one of a plurality of locations in a predetermined area;
receive selection of any one of the plurality of time series; and
display a location associated to the selected time series on a map on the display.

2. The infrastructure diagnostic device according to claim 1, wherein
the one or more processors are further configured to execute the instructions to:
display detailed information of the infrastructure states of the selected time series.

3. The infrastructure diagnostic device according to claim 1, wherein
the one or more processors are further configured to execute the instructions to:
receive selection of any one of the plurality of time series and selection of a time point in the time series, and
display detailed information of the infrastructure state at the selected time point in the selected time series.

4. The infrastructure diagnostic device according to claim 2, wherein
the detailed information is at least one of a value of an index representing the infrastructure state and an image used to calculate the value of the index.

5. The infrastructure diagnostic device according to claim 1, wherein
the one or more processors are further configured to execute the instructions to: extract, from among the plurality of locations, a location where a value of an index representing the infrastructure state satisfies a predetermined condition, and
display the time series of the infrastructure states of the extracted location.

6. The infrastructure diagnostic device according to claim 1, wherein
the one or more processors are further configured to execute the instructions to: extract, from among the plurality of locations, a location where a change in a value of an index representing the infrastructure states satisfies a predetermined condition, and
display the time series of the infrastructure states of the extracted location.

7. An infrastructure diagnostic method comprising:
displaying a plurality of time series on a display, each time series representing infrastructure states at any one of a plurality of locations in a predetermined area;
receiving selection of any one of the time series of the infrastructure state at the plurality of locations; and
displaying a location associated to the selected time series on a map on the display.

8. A recording medium that records a program for causing a computer to execute a process of:
displaying a plurality of time series on a display, each time series representing infrastructure states at a plurality of locations in a predetermined area;
receiving selection of any one of the time series of the infrastructure state at the plurality of locations; and
displaying a location associated to the selected time series on a map on the display.
